(19) United States
(12) Patent Application Publication
(10) Pub. No.: US 2026/0145432 A1
(43) Pub. Date: May 28, 2026

(54) MAINTENANCE DEVICE AND INKJET RECORDING APPARATUS

(71) Applicant: KYOCERA Document Solutions Inc., Osaka (JP)

(72) Inventors: Takashi SOMETE, Osaka (JP); Yiquan NIE, Osaka (JP)

(73) Assignee: KYOCERA Document Solutions Inc., Osaka (JP)

(21) Appl. No.: 19/393,134

(22) Filed: Nov. 18, 2025

(30) Foreign Application Priority Data
Nov. 25, 2024 (JP) 2024-204551

(51) Int. Cl. B41J 2/165

(52) U.S. Cl. CPC B41J 2/16511; B41J 2002/16594; B41P 2235/27

(57) ABSTRACT

A maintenance device includes a cap, a recovery part, an air pump, and a supply part. The cap is provided for an inkjet head and configured to be attached to a nozzle surface of the inkjet head. The recovery part has a vent port opened to an atmosphere and is configured to recover air from the cap. The air pump is configured to suck the air from the recovery part. The supply part is provided for the cap and configured to store a humidifying medium, generate a humidified air by passing air supplied from the air pump through the humidifying medium, and supply the humidified air to the cap.

### INCORPORATION BY REFERENCE

This application is based on and claims the benefit of priority from Japanese patent application No. 2024-204551 Nov. 25, 2024, which is incorporated by reference in its entirety.

### BACKGROUND

The present disclosure relates to a maintenance device and an inkjet recording apparatus.

In an inkjet recording apparatus using water-based ink, moisture evaporates from the ink in a nozzle during a period when printing is not performed, and viscosity of the ink is increased, and ejection failure or clogging may occur. Accordingly, a technique for suppressing the evaporation of moisture from the ink in the nozzle has been studied. For example, a device for supplying humidified air into a cap covering an ejection surface (a nozzle surface) of a head is discussed.

### SUMMARY

A maintenance device according to the present disclosure includes a cap, a recovery part, an air pump, and a supply part. The cap is provided for an inkjet head and configured to be attached to a nozzle surface of the inkjet head. The recovery part has a vent port opened to an atmosphere and is configured to recover air from the cap. The air pump is configured to suck the air from the recovery part. The supply part is provided for the cap and configured to store a humidifying medium, generate a humidified air by passing air supplied from the air pump through the humidifying medium, and supply the humidified air to the cap.

An inkjet recording apparatus according to the present disclosure includes the maintenance device and the inkjet head.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a perspective view showing an appearance of an image forming system according to one embodiment of the present disclosure.

FIG. 2 is a front view schematically showing an internal configuration of an inkjet recording apparatus according to the embodiment of the present disclosure.

FIG. 3 is a front view schematically showing a head unit and a maintenance device according to the embodiment of the present disclosure.

FIG. 4 is a plan view schematically showing the head unit and a wipe unit according to the embodiment of the present disclosure.

FIG. 5 is a plan view schematically showing a cap unit according to the present disclosure.

FIG. 6 is a cross-sectional view showing an inkjet head according to the embodiment of the present disclosure.

FIG. 7A is a front view showing a first stage of an operation of the maintenance device according to the embodiment of the present disclosure.

FIG. 7B is a front view showing a second stage of the operation of the maintenance device according to the embodiment of the present disclosure.

FIG. 7C is a front view showing a third stage of the operation of the maintenance device according to the embodiment of the present disclosure.

FIG. 7D is a front view showing a fourth stage of the operation of the maintenance device according to the embodiment of the present disclosure.

FIG. 7E is a front view showing a fifth stage of the operation of the maintenance device according to the embodiment of the present disclosure.

FIG. 7F is a front view showing a sixth stage of the operation of the maintenance device according to the embodiment of the present disclosure.

FIG. 7G is a front view showing a seventh stage of the operation of the maintenance device according to the embodiment of the present disclosure.

FIG. 7H is a front view showing an eighth stage of the operation of the maintenance device according to the embodiment of the present disclosure.

FIG. 8 is a perspective view showing the cap unit according to the embodiment of the present disclosure.

FIG. 9 is a plan view showing the cap unit according to the embodiment of the present disclosure.

FIG. 10 is a cross-sectional view taken along the line I-I of FIG. 9.

FIG. 11 is an exploded view showing the cap unit according to the embodiment of the present disclosure.

FIG. 12 is a view explaining a flow of humidified air in the cap unit according to the embodiment of the present disclosure.

FIG. 13 is a plan view showing a location of a supply part and a recovery part according to the embodiment of the present disclosure.

FIG. 14 is a cross-sectional view showing the flow of humidified air in the cap unit according to the embodiment of the present disclosure.

FIG. 15 is a plan view showing the recovery part according to the embodiment of the present disclosure.

FIG. 16 is a perspective view showing the recovery part according to the embodiment of the present disclosure.

### DETAILED DESCRIPTION

Hereinafter, with reference to the drawings, an inkjet recording apparatus 1 according to one embodiment of the present disclosure will be described.

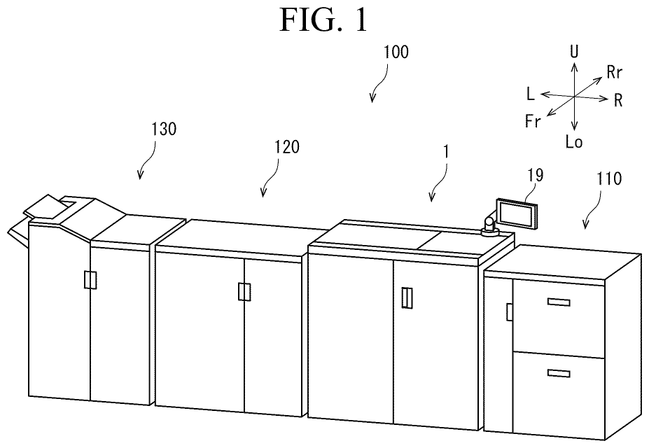

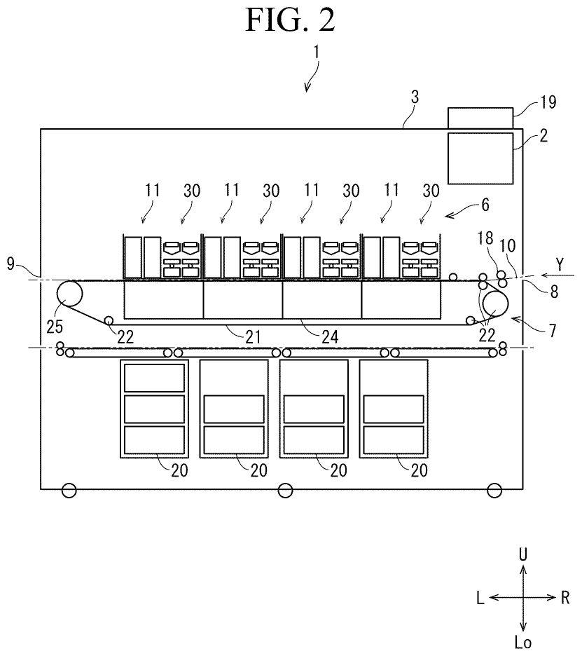

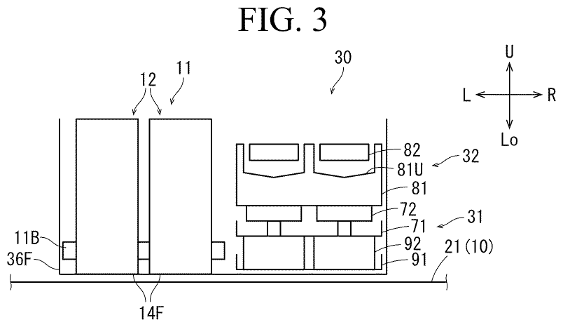

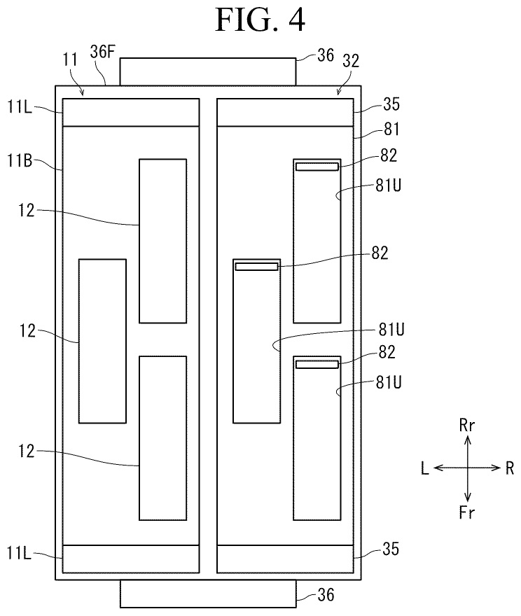

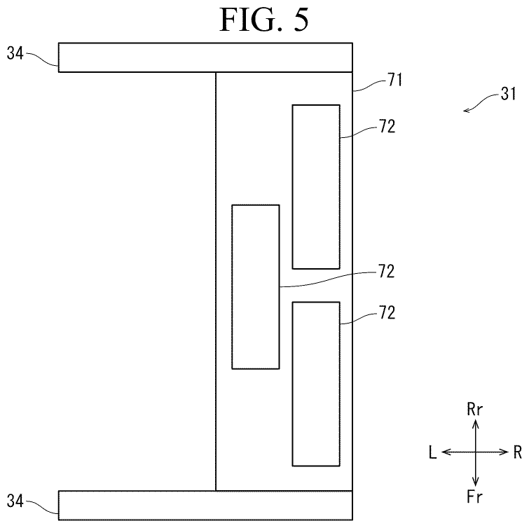

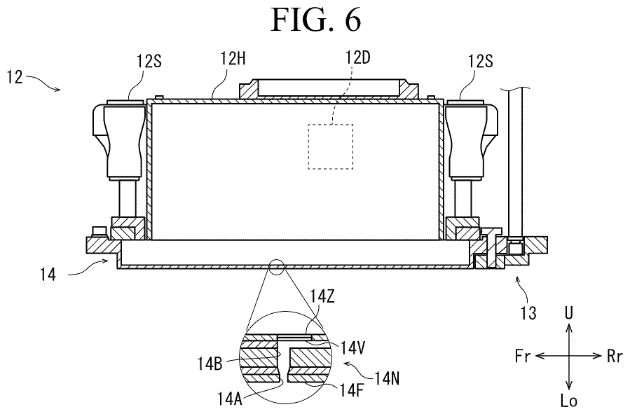

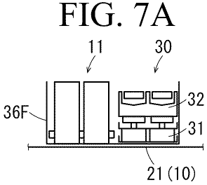

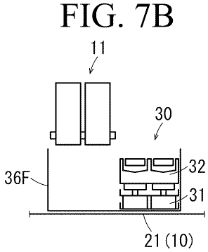

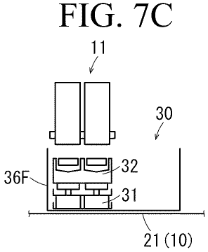

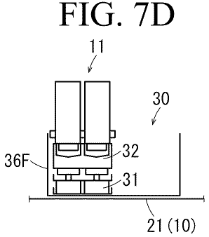

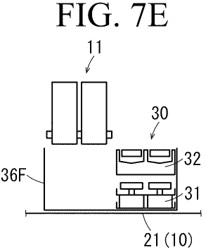

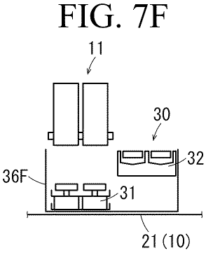

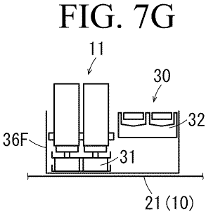

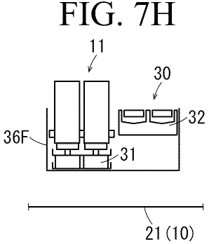

FIG. 1 is a perspective view showing an appearance of an image forming system 100. FIG. 2 is a front view schematically showing an internal configuration of the inkjet recording apparatus 1. FIG. 3 is a front view schematically showing a head unit 11 and a maintenance device 30. FIG. 4 is a plan view schematically showing the head unit 11 and a wipe unit 32. FIG. 5 is a plan view schematically showing a cap unit 31. FIG. 6 is a cross-sectional view showing an inkjet head 12. FIG. 7A to FIG. 7H are front views explaining an operation of the maintenance device 30. Hereinafter, the front side of the paper plane on which FIG. 2 is drawn will be referred to as the front side of the inkjet recording apparatus 1, and the left-and-right direction will be described with reference to the direction in which the inkjet recording apparatus 1 is viewed from the front side. In each figure, U, Lo, L, R, Fr, and Rr indicate an upper, lower, left, right, front, and rear, respectively.

The image forming system 100 (see FIG. 1) includes a sheet feeding device 110, the inkjet recording apparatus 1, a drying device 120, and a post-processing device 130. The sheet feeding device 110 stores several thousand sheets and feeds the sheets to the inkjet recording apparatus 1. The inkjet recording apparatus 1 forms an image on the sheet by an inkjet method. The drying device 120 heats the sheet conveyed from the inkjet recording apparatus 1 to dry the ink. The post-processing device 130 performs post-processing such as punching, stapling, folding, or the like on the sheet conveyed from the drying device 120.

The inkjet recording apparatus 1 (see FIG. 2) includes a parallelepiped body housing 3. In the center portion inside the body housing 3, a conveying unit 7 which attracts and conveys the sheet in the Y direction is provided. Above the conveying unit 7, an image forming unit 6 which forms an image by ejecting the ink is provided. On the right side surface of the body housing 3, a sheet feeding port 8 through which the sheet is introduced from the sheet feeding device 110 is provided. On the left side surface of the body housing 3, a discharge port 9 is provided, and through the discharge port 9, the sheet on which the image is formed is discharged to the drying device 120. Inside the body housing 3, a conveying path 10 is provided from the sheet feeding port 8 to the discharge port 9 through a gap between the conveying unit 7 and the image forming unit 6. A registration roller 18 is provided on the upstream side of the conveying unit 7 in the conveying direction Y.

The conveying unit 7 includes an endless conveying belt 21 and a suction part 24. The conveying belt 21 has a large number of air holes (not shown), and is wound around a driving roller 25 and a driven roller 22. The upper surface of the suction part 24 has a large number of air holes (not shown), and is in contact with the inner surface of the conveying belt 21. The suction part 24 sucks air through the air holes of the conveying belt 21 and the air holes of the suction part 24, thereby attracting the sheet to the conveying belt 21. When the driving roller 25 is driven in the counterclockwise direction by a driving part (not shown) including a motor and a reduction gear, the conveying belt 21 travels in the counterclockwise direction, and the sheet attracted to the conveying belt 21 is conveyed in the Y direction.

The image forming unit 6 includes a plurality (in this embodiment, four) of head units 11. The head unit 11 (see FIG. 3 and FIG. 4) includes one or more (in this embodiment, three) inkjet heads 12. Ink containers 20 filled with the black, cyan, magenta and yellow inks are connected to the head units 11.

The inkjet head 12 (see FIG. 6) includes a parallelepiped housing 12H whose longitudinal direction is along in the front-and-rear directions, a nozzle plate 14 provided at the bottom of the housing 12H, and a socket 12S to which a pipe for supplying the ink is connected. The nozzle plate 14 includes a large number of nozzles 14N arranged in the front-and-rear direction. The nozzle 14N includes a branch flow path 14B branched from the downstream side of the socket 12S, and an ejection port 14A provided on a nozzle surface 14F which is a lower surface of the nozzle plate 14. A diaphragm 14V also serves as a part of the inner wall of the branch flow path 14B. The diaphragm 14V is provided with a pressurizing element 14Z. As the pressurizing element 14Z, a piezoelectric element, an electrostatic actuator, a heater, or the like is used. A driving circuit 12D for driving the pressurizing element 14Z is connected to the pressurizing element 14Z.

A control part 2 (see FIG. 2) includes an arithmetic part and a storage part (not shown). The arithmetic part is, for example, a CPU (Central Processing Unit). The storage part includes a storage medium such as a ROM (Read Only Memory), a RAM (Random Access Memory), an EEPROM (Electrically Erasable Programmable Read Only Memory), and the like. The arithmetic part reads out the control program stored in the storage part and executes various processes. The control part 2 may be implemented by an integrated circuit that does not use software.

A display operation part 19 is provided on the upper portion of the body housing 3 (see FIG. 1 and FIG. 2). The display operation part 19 includes a display panel, a touch panel laminated on the display panel, and a keypad (not shown). The control part 2 displays a screen representing an operation menu, a status, or the like of the inkjet recording apparatus 1 on the display panel and controls each part of the inkjet recording apparatus 1 in accordance with an operation detected by the touch panel and the keypad.

The basic image forming operation of the inkjet recording apparatus 1 is as follows. When an image forming job is inputted to the inkjet recording apparatus 1 from the display operation part 19 or an external computer, the sheet feeding device 110 feeds the sheet to the conveying path 10 through the sheet feeding port 8, and the registration roller 18 whose rotation is stopped corrects the skew of the sheet. When the registration roller 18 sends the sheet to the conveying unit 7 at a predetermined timing, the conveying unit 7 attracts the sheet to the conveying belt 21 and conveys the sheet in the Y direction. The ink is ejected from the inkjet head 12 on the sheet to form an image on the sheet. The sheet on which the image is formed is discharged to the drying device 120 through the discharge port 9.

[Maintenance Device] Next, a maintenance device 30 will be described. Since the four head units 11 have the same configuration and the four maintenance devices 30 have the same configuration, one head unit 11 and one maintenance device 30 provided on the right side of the head unit 11 will be described below.

The head unit 11 includes a head base 11B (see FIG. 3 and FIG. 4) by which the inkjet head 12 is supported. On the head base 11B, the three inkjet heads 12 are arranged in a staggered pattern.

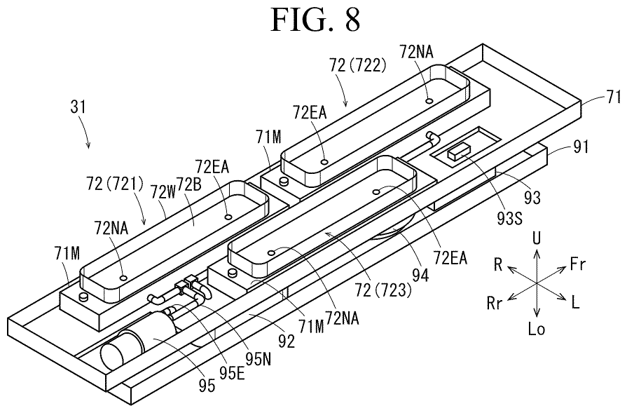

The maintenance device 30 (see FIG. 3) is provided on the lateral side (in this embodiment, the right side) of the head unit 11. The maintenance device 30 includes a cap unit 31 and a wipe unit 32.

[Cap Unit] The cap unit 31 (see FIG. 3 and FIG. 5) incudes caps 72 having the same number (in this embodiment, three) as the number of the inkjet heads 12 provided in the head unit 11. The three caps 72 are arranged in a staggered pattern in the same manner as the inkjet heads 12. The three caps 72 are attached on the upper surface of a plate shaped frame body 71 via pedestal portions 71M (see FIG. 8 to FIG. 11). Two caps 72 are arranged in the front-and-rear direction of the frame body 71 on the right side of the center in the left-and-right direction of the frame body 71, and one cap 72 is arranged on the left side. One left cap 72 is disposed at an intermediate position of the two right caps 72 in the front-and-rear direction.

[Wipe Unit] The wipe unit 32 (see FIG. 3 and FIG. 4) includes a waste liquid tray 81 and a cleaning member 82. The waste liquid tray 81 has the same number of recesses 81U as the number of the inkjet heads 12 provided in the head unit 11. The recesses 81U are arranged in a staggered pattern in the same manner as the inkjet heads 12. The cleaning member 82 is provided in each of the recesses 81U. The cleaning member 82 is, for example, a blade. The waste liquid tray 81 includes a driving part (not shown) for sliding the cleaning members 82 along the nozzle surfaces 14F. The waste liquid tray 81 is placed on the caps 72. In other words, the wipe unit 32 is placed on the cap unit 31. The head unit 11 is provided with a cleaning liquid supply device 13 (see FIG. 6) for supplying cleaning liquid to the nozzle surface 14F.

[Head Lifting Device] Head lifting devices 11L (see FIG. 4) are provided on the front and rear sides of the head base 11B, respectively. The head lifting device 11L includes, for example, a ball screw, a belt driving device, and the like. The head lifting devices 11L lift and lower the head unit 11 between an image forming position and a retracted position. The image forming position (see FIG. 7A) is a position where a distance between the conveying path 10 (the upper surface of the conveying belt 21) along which the sheet S is conveyed and the nozzle surface 14F is a predetermined distance suitable for the image forming. The image forming position is the lower limit position of the lifting range of the head unit 11 by the head lifting devices 11L. The retracted position (see FIG. 7B) is a position where the head unit 11 does not interfere with the wipe unit 32 when the cap unit 31 and the wipe unit 32 are slid using a cap sliding device 34 described later. The retracted position is the upper limit position of the lifting range of the head unit 11.

[Cap Sliding Device] The cap sliding devices 34 (see FIG. 5) are provided on the front and rear sides of the frame body 71 of the cap unit 31, respectively. The cap sliding device 34 includes, for example, a ball screw, a belt driving device, and the like. The cap sliding devices 34 slide the cap unit 31 to a home position and a maintenance position. The home position (see FIG. 7A) is a position on the right side of the head unit 11 positioned at the image forming position. The maintenance position (see FIG. 7F) is a position below the head unit 11 positioned at the retracted position.

[Wipe Lifting Device] Wipe lifting devices 35 (see FIG. 4) are provided on the front and rear sides of the waste liquid tray 81 of the wipe unit 32, respectively. The wipe lifting device 35 includes, for example, a ball screw, a belt driving device, and the like. The wipe lifting devices 35 lift and lower the wipe unit 32 to a contact position (see FIG. 7B) where the waste liquid tray 81 comes into contact with the caps 72 and a separated position (see FIG. 7E) where the waste liquid tray 81 is separated from the caps 72 by a predetermined distance.

[Unit Lifting Device] The head lifting devices 11L, the cap sliding devices 34, and the wipe lifting devices 35 are attached to a frame body 36F. In other words, the head unit 11 is supported by the frame body 36F via the head lifting devices 11L. The cap unit 31 is supported by the frame body 36F via the cap sliding devices 34. The wipe unit 32 is supported by the frame body 36F via the wipe lifting devices 35.

Unit lifting devices 36 are provided at the front and rear of the frame body 36F. The unit lifting devices 36 are supported by the body housing 3. The unit lifting devices 36 include, for example, ball screws, belt driving devices, and the like and lift and lower the frame body 36F. That is, the unit lifting devices 36 lift and lower the head unit 11 and the maintenance device 30 collectively. The unit lifting devices 36 lift and lower the head unit 11 and the maintenance device 30 between a normal position and a retracted position. When the image forming by the head unit 11 or maintenance by the maintenance device 30 are performed, the frame body 36F is positioned at the normal position (see FIG. 7A to FIG. 7G). When the sheet is jammed on the conveying belt 21, the frame body 36F is positioned at the retracted position (see FIG. 7H) to facilitate removal of the sheet, and the distance between the conveying belt 21 and the frame body 36F is increased.

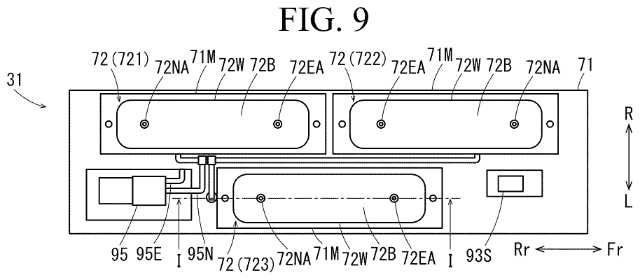

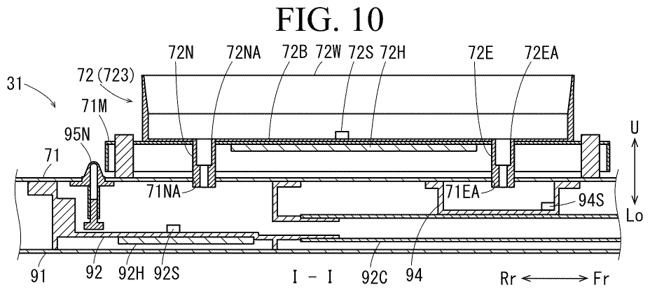

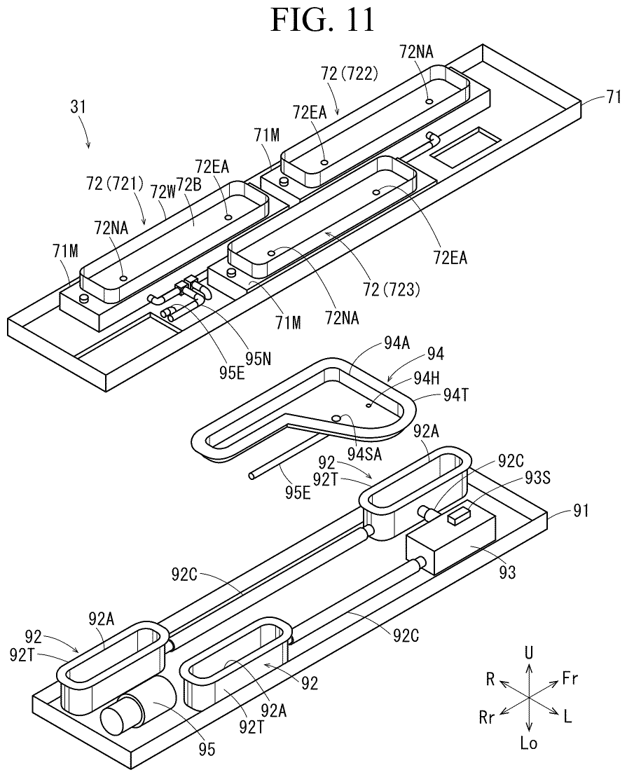

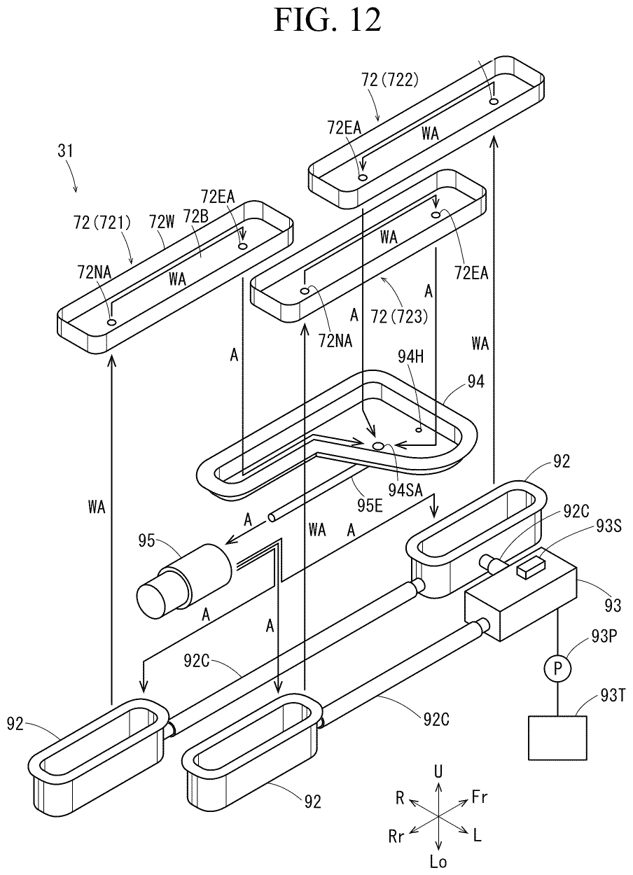

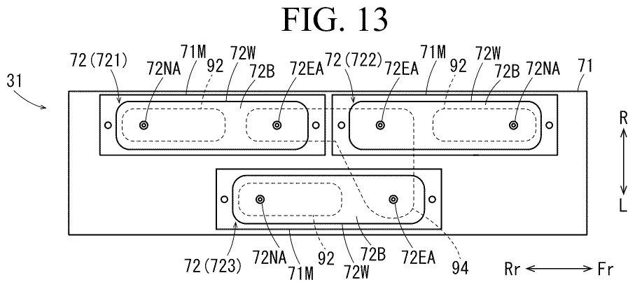

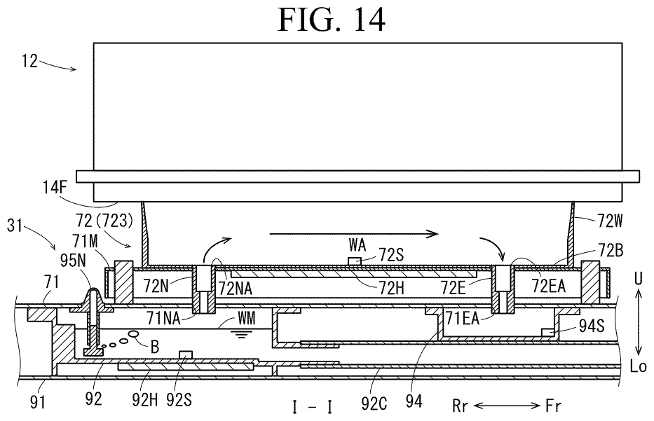

Next, a configuration of the cap unit 31 will be described in detail. FIG. 8 is a perspective view showing the cap unit 31. FIG. 9 is a plan view showing the cap unit 31. FIG. 10 is a cross-sectional view taken along the line I-I in FIG. 9. FIG. 11 is an exploded view showing the cap unit 31. FIG. 12 is a view explaining a flow of humidified air WA in the cap unit 31. FIG. 13 is a plan view showing positions of a supply part 92 and a recovery part 94. FIG. 14 is a cross-sectional view explaining a flow of humidified air WA in the cap 72.

The maintenance device 30 according to the embodiment includes a plurality of the caps 72 to be attached on the nozzle surfaces 14F of the inkjet heads 12, an air supply port 72NA and an air discharge port 72EA which are provided in each of the caps 72. The maintenance device 30 includes one recovery part 94 which recovers air A through the air discharge ports 72EA of all the caps 72, and a plurality of supply parts 92 which are provided for the caps 72 and supply, to the air supply ports 72NA, humidified air WA generated by humidifying the air A recovered by the recovery part 94. The supply parts 92 are arranged around the recovery part 94. In each of the caps 72, the air discharge port 72EA is provided on the side of the recovery part 94. The air supply port 72NA is provided on the side of the supply part 92.

The caps 72 include a first cap 721, a second cap 722, and a third cap 723. The first cap 721 and the second cap 722 are arranged along a predetermined direction (for example, in the front-and-rear direction), and the third cap 723 is arranged at an intermediate position between the first cap 721 and the second cap 722 in the predetermined direction. The third cap 723 is arranged at a position different from the first cap 721 and the second cap 722 in a direction intersecting the predetermined direction. The air discharge port 72EA of the first cap 721 is provided on the side of the second cap 722, and the air discharge port 72EA of the second cap 722 is provided on the side of the first cap 721.

[Cap] The cap 72 (see FIG. 8 to FIG. 10) is formed in the box-shape opened upwardly. The cap 72 has a generally rectangular bottom portion 72B whose longitudinal direction is along the front-and-rear direction and a side wall portion 72W standing upwardly from the edge of the bottom portion 72B. The side wall portion 72W is made of material having flexibility such as rubber. The bottom portion 72B is provided with the air supply port 72NA and the air discharge port 72EA. In the right rear cap 72 and the left cap 72, the air supply port 72NA is provided on the rear side, and the air discharge port 72EA is provided on the front side. In the right front cap 72, the air supply port 72NA is provided on the front side, and the air discharge port 72EA is provided on the rear side.

The three caps 72 are arranged in a staggered pattern. The first cap 721 is arranged on the right rear portion on the frame body 71, the second cap 722 is arranged in front of the first cap 721, and the third cap 723 is arranged on the left side portion on the frame body 71. In the first cap 721 and the third cap 723, the air discharge port 72EA is provided on the front side, and the air supply port 72NA is provided on the rear side. In the second cap 722, the air discharge port 72EA is provided on the rear side, and the air supply port 72NA is provided on the front side. In the second cap 722, the air discharge port 72EA may be provided on the front side and the air supply port 72NA may be provided on the rear side.

[Supply Part and Recovery Part] Below the frame body 71 (see FIG. 8 and FIG. 11 to FIG. 13), the supply parts 92 and one recovery part 94 are provided, and the number of the supply parts 92 is the same as the number of the caps 72 (in this embodiment, three). The supply part 92 includes a tank 92T. The recovery part 94 includes a tank 94T. The supply parts 92 and the recovery part 94 are supported by a frame body 91. The supply parts 92 are arranged below the air supply ports 72NA of the corresponding caps 72. The recovery part 94 has a shape overlapping all the air discharge ports 72EA in plan view, and is arranged below all the air discharge ports 72EA.

In other words, the three supply parts 92 are arranged around one recovery part 94, in each of the three caps 72, the air discharge port 72EA is provided on the side of the recovery part 94, and the air supply port 72NA is provided on the side of the supply part 92. In other words, all the air discharge ports 72EA overlap the recovery part 94 in the upper-and-lower direction, and in each of the caps 72, the air supply port 72NA overlaps the supply part 92 in the upper-and-lower direction.

The tank 92T has an opening 92A opened upward (see FIG. 11). The tank 94T has an opening 94A opened upward. The tank 92T and the tank 94T are joined on the lower surface of the frame body 71. That is, the opening 92A and the opening 94A are closed with the frame body 71. In other words, the frame body 71 serves as the ceilings of the tank 92T and the tank 94T.

An air supply pipe 72N (see FIG. 10) is connected to the air supply port 72NA of each of the caps 72 so as to communicate the cap 72 with the supply part 92 below the corresponding cap 72. An air discharge pipe 72E is connected to the air discharge port 72EA of each of the caps 72 so as to communicate the cap 72 with the recovery part 94. That is, the three caps 72 communicate with the recovery part 94.

The frame body 71 has an air supply port 71NA below the air supply port 72NA and an air discharge port 71EA below the air discharge port 72EA. The air supply pipe 72N passes through the air supply port 71NA. The air discharge pipe 72E passes through the air discharge port 71EA.

An air pump 95 is connected to the recovery part 94 by a recovery flow path 95E (see FIG. 8, FIG. 9 and FIG. 11) and is connected to all the supply parts 92 by a supply flow path 95N. The recovery flow path 95E is connected to a suction port 94SA provided in the bottom portion of the tank 94T of the recovery part 94. The air pump 95 recovers the air A having a decreased water vapor pressure from the recovery part 94 through the recovery flow path 95E and supplies the recovered air A to all the supply parts 92 through the supply flow path 95N (see FIG. 12).

All the supply parts 92 are connected to a sub-tank 93 through communication pipes 92C (see FIG. 10, FIG. 11 and FIG. 12). A tank 93T and a pump 93P are connected to the sub-tank 93. A humidifying medium WM (see FIG. 14) is stored in the tank 93T. The humidifying medium WM is, for example, water, but any liquid containing water may be used. The pump 93P supplies the humidifying medium WM from the tank 93T to the sub-tank 93. When an amount of the humidifying medium WM in the supply part 92 decreases, the humidifying medium WM is replenished from the sub-tank 93 to the supply part 92 by the head difference with the sub-tank 93, and the height of the liquid surfaces of the supply parts 92 and the sub-tank 93 is made uniform. Only by managing the amount of the humidifying medium WM in the sub-tank 93, the amount of the humidifying medium WM in the supply parts 92 can also be managed.

The sub-tank 93 is provided with a sensor 93S (see FIG. 8, FIG. 9, FIG. 11 and FIG. 12) for detecting an amount of the humidifying medium WM in the sub-tank 93. The sensor 93S detects, for example, a height of the liquid surface in the sub-tank 93. The supply part 92 is provided with a first heating part 92H (see FIG. 10) for heating the supply part 92. The cap 72 is provided with a second heating part 72H for heating the cap 72. The supply part 92 is provided with a sensor 92S for measuring a temperature in the supply part 92. The cap 72 is provided with a sensor 72S for measuring a temperature in the cap 72. The recovery part 94 is provided with a sensor 94S for measuring at least one of a temperature and a humidity in the recovery part 94.

Next, the basic operation of the maintenance device 30 will be described. In the initial state (see FIG. 7A), the frame body 36F is positioned at the normal position, the head unit 11 is positioned at the image forming position, and the cap unit 31 is positioned at the home position. The wipe unit 32 is placed on the cap unit 31. That is, the waste liquid tray 81 is in contact with the caps 72. The control part 2 executes the following processing at a predetermined timing. The predetermined timing is, for example, a timing in which a viscosity of the ink in the nozzle 14N is expected to increase, and more specifically, a case in which a period in which the image forming job is not executed continues for a predetermined period.

First, the control part 2 operates the head lifting devices 11L to lift the head unit 11 to the retracted position (see FIG. 7B). Next, the control part 2 operates the cap sliding devices 34 to slide the cap unit 31 to the maintenance position (see FIG. 7C). At this time, since the wipe unit 32 is placed on the cap unit 31, the wipe unit 32 slides to the maintenance position together with the cap unit 31. Next, the control part 2 operates the head lifting devices 11L to lower the head unit 11 to a height at which the nozzle surface 14F comes into contact with the cleaning member 82 (see FIG. 7D).

Next, the control part 2 forcibly ejects a predetermined amount of the ink from the inkjet head 12 (purge processing), supplies the cleaning liquid to the nozzle surface 14F, and slides the cleaning member 82 along the nozzle surface 14F (wiping processing). Then, the ink remaining on the nozzle surface 14F is diluted by the cleaning liquid, and the waste liquid containing the ink and the cleaning liquid is scraped off by the cleaning member 82 and falls on the waste liquid tray 81.

Next, the control part 2 operates the head lifting devices 11L to lift the head unit 11 to the retracted position (see FIG. 7C). Next, the control part 2 operates the cap sliding devices 34 to slide the cap unit 31 and the wipe unit 32 to the home position (see FIG. 7B).

Next, the control part 2 operates the wipe lifting devices 35 to lift the wipe unit 32 to the separated position (see FIG. 7E). Next, the control part 2 operates the cap sliding devices 34 to slide the cap unit 31 to the maintenance position (see FIG. 7F). At this time, since the wipe unit 32 is separated from the cap unit 31, the wipe unit 32 remains at the home position and only the cap unit 31 slides to the maintenance position.

Next, the control part 2 operates the head lifting devices 11L to lower the head unit 11 to a height at which the nozzle surface 14F comes into contact with the cap 72 (see FIG. 7G). Thus, the cap 72 is attached on the nozzle surface 14F.

Next, the control part 2 humidifies the inside of the cap 72. The control part 2 monitors the measured value by the sensor 93S and maintains a height of the liquid surface in the sub-tank 93 within a predetermined range. Specifically, when the measured value of the liquid surface is lowered than the predetermined range, a predetermined amount of the humidifying medium WM is replenished from the tank 93T to the sub-tank 93 by using the pump 93P. Since the sub-tank 93 communicates with the supply parts 92 by the communication pipes 92C, a height of the liquid surface of the humidifying medium WM is uniform in the sub-tank 93 and all the supply parts 92.

The air pump 95 (see FIG. 12) recovers the air A having a decreased water vapor pressure from the recovery part 94 through the recovery flow path 95E and supplies the recovered air A to all the supply parts 92 through the supply flow path 95N. An end portion of the supply flow path 95N on the side of the supply part 92 is disposed below the liquid surface of the humidifying medium WM (see FIG. 14). Therefore, the air A is blown into the humidifying medium WM in the supply part 92, and bubbles B are generated. A water vapor pressure of the bubbles B increases until the bubbles B float upward to the liquid surface. In addition, since the humidifying medium WM in the supply part 92 is heated by the first heating part 92H, water vapor is easily generated. Therefore, a space above the liquid surface in the supply part 92 is filled with the humidified air WA having an increased water vapor pressure, and the humidified air WA flows into the cap 72 through the air supply pipe 72N. The air pump 95 may recover and supply the air A continuously or intermittently.

On the other hand, since the air A in the recovery part 94 is sucked by the air pump 95, a negative pressure is generated in the recovery part 94. Therefore, an air flow of the humidified air WA from the air supply port 72NA to the air discharge port 72EA is generated in the cap 72. In addition, since the humidified air WA supplied to the cap 72 is heated by the first heating part 92H, convection is generated in the cap 72, and the high-temperature humidified air WA is supplied to the nozzle surface 14F. Thus, the humidified air WA is exposed to the ink in the nozzles 14N, and the viscosity increase of the ink is suppressed.

In addition to the above control, the control part 2 executes temperature control of each part. Specifically, each of the inkjet heads 12 is provided with a sensor (not shown) for measuring a temperature of the inkjet head 12 (for example a temperature of the ink in the nozzle 14N). As described above, the supply part 92 is provided with the first heating part 92H (see FIG. 10) for heating the supply part 92. The cap 72 is provided with the second heating part 72H for heating the cap 72. The supply part 92 is provided with the sensor 92S for measuring a temperature in the supply part 92. The cap 72 is provided with the sensor 72S for measuring a temperature in the cap 72. The recovery part 94 is provided with the sensor 94S for measuring at least one of a temperature and a humidity in the recovery part 94.

The control part 2 monitors the measured value by the sensor 92S and controls the first heating part 92H so that a temperature of the supply part 92 is equal to or higher than a temperature of the inkjet head 12. If a temperature of the supply part 92 is less than a temperature of the inkjet head 12, there is a possibility that a humidity of the humidified air WA supplied from the supply part 92 becomes lower than that in the nozzle 14N of the inkjet head 12. In this case, a humidifying effect on the ink in the nozzle 14N cannot be obtained. On the other hands, in the present embodiment, the humidified air WA having a higher humidity than that in the nozzle 14N of the inkjet head 12 is supplied.

The control part 2 monitors the measured value by the sensor 72S and controls the second heating part 72H so that a temperature of the cap 72 is equal to or higher than a temperature of the supply part 92. If a temperature of the cap 72 is less than a temperature of the supply part 92, a temperature of the humidified air WA supplied from the supply part 92 is lowered in the cap 72. If a temperature of the humidified air WA is lower than the dew point, dew condensation occurs, and a humidity in the cap 72 is decreased, and the humidifying effect cannot be obtained. On the other hand, in the present embodiment, since a temperature of the humidified air WA is not lowered in the cap 72, there is no possibility that a humidity in the cap 72 decreases due to the dew condensation.

When the image forming job is executed, the control part 2 operates the head lifting devices 11L to lift the head unit 11 to the retracted position (see FIG. 7F), operates the cap sliding devices 34. The control part 2 slides the cap unit 31 to the home position (see FIG. 7E), and operates the wipe lifting devices 35 to lower the wipe unit 32 to the contact position (see FIG. 7B). Then, the control part 2 operates the head lifting devices 11L to lower the head unit 11 to the image forming position (see FIG. 7A) and executes the image forming job.

When the sheet is jammed between the conveying belt 21 and the frame body 36F during image forming, the control part 2 operates the unit lifting devices 36 to lift the frame body 36F to the retracted position (see FIG. 7H). When the user removes the sheet and instructs the display operation part 19 to resume the image forming, the control part 2 operates the unit lifting devices 36 to lower the frame body 36F to the normal position (see FIG. 7A), and resumes the image forming job.

Here, a change in air pressure inside the cap 72 when the cap 72 is attached to and detached from the nozzle surface 14F will be described. When the nozzle surface 14F is humidified, after the cap 72 is attached to the nozzle surface 14F, the air pump 95 is driven, and a circulation of air A from the air pump 95 through the supply parts 92, the caps 72, and the recovery part 94 and back to the air pump 95 is generated. In the supply part 92, the air A is blown into the humidifying medium WM, and bubbles B are generated. The water vapor pressure of the bubble B increases until the bubbles B floats to the liquid surface. Further, since the humidifying medium WM in the supply part 92 is heated by the first heating part 92H, water vapor is easily generated. Therefore, a space above the liquid surface of the supply part 92 is filled with the humidified air WA having a high water vapor pressure, and the humidified air WA flows into the cap 72 through the supply pipe 72N.

Then, since the air pressure inside the supply part 92 and the cap 72 increases, the liquid surface of the humidifying medium WM is pushed in the supply part 92, and the humidifying medium WM is pushed back to the sub-tank 93 through the communication pipe 92C. As a result, the liquid surface of the sub-tank 93 rises, and the liquid surface of the supply part 92 falls. When the liquid surface of the sub-tank 93 rises, the humidifying medium WM may overflow from the sub-tank 93. Further, when the air pressure inside the cap 72 increases, the ink having an increased viscosity is pushed back into the nozzle 14N, and there is a possibility of causing an ejection failure. Further, since the side wall portion 72W of the cap 72 is made of flexible material such as rubber, the side wall portion 72W expands in the horizontal direction due to an increase in the air pressure inside the cap 72.

Thereafter, when the humidification of the nozzle surface 14F is finished, the air pump 95 is stopped, but the air pressure inside the supply part 92 and the cap 72 does not immediately return to the atmospheric pressure. Therefore, when the cap 72 is detached from the nozzle surface 14F, the humidified air WA having an increased air pressure flows out from the cap 72 and the supply part 92 suddenly, and the air pressure inside the cap 72 and the supply part 92 returns to the atmospheric pressure. As a result, the liquid surface of the supply part 92 rises and the liquid surface of the sub-tank 93 falls. When the liquid surface of the supply part 92 rises, the humidifying medium WM may enter the cap 72 through the air supply pipe 72N and the air discharge pipe 72E.

Therefore, the maintenance device 30 according to the present embodiment is provided with a configuration for suppressing a pressure change inside the cap 72 when the cap 72 is attached to and detached from the inkjet head 12. More specifically, a vent port 94H is provided at the bottom portion of the tank 94T of the recovery part 94 (see FIG. 11 and FIG. 12). The vent port 94H penetrates the bottom portion of the tank 94T in the upper-and-lower direction and is open to the atmosphere. With this configuration, when the air pressure inside the cap 72 increase, a part of the air A flows out into the atmosphere through the vent port 94H, so that the increase in the air pressure inside the cap 72 and the supply part 92 is mitigated. In addition, when the air pump 95 is stopped, a small amount of air enters through the vent port 94H, and the air pressure gradually decreases, so that the sudden decrease of the air pressure inside the cap 72 and the supply part 92 when the cap 72 is detached from the nozzle surface 14F can be suppressed.

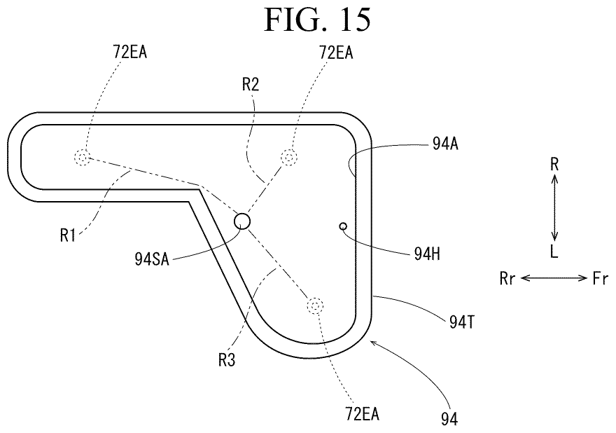

FIG. 15 is a plan view showing the recovery part 94. The vent port 94H is provided at a position which does not overlap with the shortest paths R1, R2 and R3 from the air discharge port 72EA to the suction port 94SA of each cap 72. With this configuration, when the nozzle surface 14F is humidified, the outflow of the air A through the vent port 94H is suppressed, so that the reduction in the suction efficiency of the air pump 95 is suppressed.

The maintenance device 30 according to the present embodiment described above includes the cap 72 provided for the inkjet head 12 and configured to be attached to the nozzle surface 14F of the inkjet head 12. The maintenance device 30 includes the recovery part 94 configured to recover the air A from the cap 72 and the air pump 95 configured to suck the air A from the recovery part 94. Further, the maintenance device 30 includes the supply part 92 provided for the cap 72 and configured to store the humidifying medium WM, generate the humidified air WA by passing the air A supplied from the air pump 95 through the humidifying medium WM, and supply the humidified air WA to the cap 72. The recovery part 94 has the vent port 94H opened to the atmosphere. According to this configuration, the maintenance device 30 can suppress the pressure change inside the cap 72 when the cap 72 is attached to and detached from the nozzle surface 14F.

According to the maintenance device 30 according to the present embodiment, the cap 72 has the air discharge port 72EA configured to discharge the air A to the recovery part 94. The recovery part 94 has the suction port 94SA connected to the air pump 95. Further, the vent port 94H is provided at a position different from a position which overlaps with at least one of the shortest paths R1, R2 and R3 from the air discharge port 72EA to the suction port 94SA. According to this configuration, the maintenance device 30 can suppress the reduction in the suction efficiency of the air pump 95.

The inkjet recording apparatus 1 according to the present embodiment includes the inkjet head 12 and the maintenance device 30. According to this configuration, the inkjet recording apparatus 1 can suppress the increase in the viscosity of the ink in the nozzle 14N of the inkjet head 12.

In the inkjet recording apparatus 1 according to the present embodiment, the cap 72 is detachable from the nozzle surface 14F of the inkjet head 12. The inkjet recording apparatus 1 further includes the sub-tank 93 configured to store the humidifying medium WM. The sub-tank 93 and the supply part 92 are communicated with each other through the communication pipe 92C so that the height of the liquid surface of the humidifying medium WM stored by the sub-tank 93 and the height of the liquid surface of the humidifying medium WM stored by the supply part 92 are synchronized. In addition, the supply part 92 and the cap 72 are communicated with each other through the air supply pipe 72N, and the cap 72 and the recovery part 94 are communicated with each other through the air discharge pipe 72E so that the air pressure inside the supply part 92, the air pressure inside the cap 72, and the air pressure inside the recovery part 94 having the vent port 94H opened to the atmosphere are synchronized.

When the air A recovered from the cap 72 is supplied to the supply part 92 by the air pump 95, the air pressure inside the cap 72 and the air pressure inside the supply part 92 may change to a pressure different from the atmospheric pressure. However, according to these configurations, the cap 72 and the supply part 92 communicate with the recovery part 94 having the vent port 94H opened to the atmosphere. Therefore, the inkjet recording apparatus 1 can suppress that the difference between the atmospheric pressure and the air pressure inside the cap 72 and the difference between the atmospheric pressure and the air pressure inside the supply part 92 are increased due to the driving of the air pump 95.

Further, since the inkjet recording apparatus 1 can suppress the increase in the difference with the atmospheric pressure, it can suppress the change in air pressure inside the cap 72, which occurs when the cap 72 is detached from the nozzle surface 14F. Therefore, the inkjet recording apparatus 1 can suppress the change in pressure inside the supply part 92 communicating with the cap 72 when the cap 72 is detached.

Therefore, the inkjet recording apparatus 1 can suppress the change in the liquid surface of the humidifying medium WM stored in the supply part 92 due to at least one of the driving of the air pump 95 or the detachment of the cap 72. Therefore, the inkjet recording apparatus 1 can suppress the overflow of the humidifying medium WM from at least one of the supply part 92 or the sub-tank 93 communicating with the supply part 92. Furthermore, the inkjet recording apparatus 1 can suppress the intrusion of the humidifying medium WM into the cap 72 communicating with the supply part 92.

The above embodiment may be modified as follows.

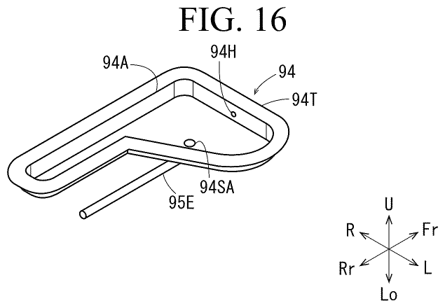

FIG. 16 is a perspective view showing the recovery part 94 according to a modified example. The vent port 94H may be provided on a surface different from the surface on which the suction port 94SA of the recovery part 94 is provided. In the example of FIG. 16, the suction port 94SA is provided at the bottom portion of the tank 94T, and the vent port 94H is provided at the side wall of the tank 94T. According to this configuration, since the vent port 94H can be separated from the suction port 94SA, the outflow of the air A through the vent port 94H is suppressed when the nozzle surface 14F is humidified, and the reduction in the suction efficiency of the air pump 95 is suppressed.

A diameter of the vent port 94H may be smaller than a diameter of the suction port 94SA (see FIG. 15 and FIG. 16). With this configuration, when the nozzle surface 14F is humidified, the outflow of the air A through the vent port 94H is suppressed, and the reduction in the suction efficiency of the air pump 95 is suppressed.

While the present disclosure has been described for specific embodiments, the present disclosure is not limited to those embodiments. Without departing from the scope and spirit of the present disclosure, those skilled in the art may modify the embodiments described above.

1. A maintenance device comprising:
a cap provided for an inkjet head and configured to be attached to a nozzle surface of the inkjet head;
a recovery part which has a vent port opened to an atmosphere and is configured to recover air from the cap;
an air pump configured to suck the air from the recovery part; and
a supply part provided for the cap and configured to store a humidifying medium, generate a humidified air by passing air supplied from the air pump through the humidifying medium, and supply the humidified air to the cap.

2. The maintenance device according to claim 1, wherein
the inkjet head is a first inkjet head, and the cap is a first cap,
the maintenance device further comprises a second cap which is a cap different from the first cap, provided for a second inkjet head different from the first inkjet head, and configured to be attached to a nozzle surface of the second inkjet head,
the recovery part is configured to recover the air from the first cap and air from the second cap,
the supply part is a first supply part, and
the maintenance device further comprises a second supply part which is a supply part different from the first supply part, provided for the second cap, and configured to store a humidifying medium, generate a humidified air by passing air supplied from the air pump through the humidifying medium, and supply the humidified air to the second cap.

3. The maintenance device according to claim 1, wherein
the cap has a discharge port configured to discharge the air to the recovery part,
the recovery part has a suction port connected to the air pump, and
the vent port is provided at a position different from a position which overlaps with a shortest path from the discharge port to the suction port.

4. The maintenance device according to claim 1, wherein
the recovery part has a suction port connected to the air pump, and
the vent port is provided on a surface of the recovery part different from a surface on which the suction port is provided.

5. The maintenance device according to claim 1, wherein
the recovery part has a suction port connected to the air pump, and
a diameter of the vent port is smaller than a diameter of the suction port.

6. The maintenance device according to claim 1, wherein
the cap is detachable from the nozzle surface of the inkjet head.

7. The maintenance device according to claim 1, wherein
the maintenance device further comprises a tank configured to store the humidifying medium,
the tank and the supply part are communicated with each other through a communication pipe so that a height of liquid surface of the humidifying medium stored by the tank and a height of liquid surface of the humidifying medium stored by the supply part are synchronized, and
the supply part and the cap are communicated with each other through an air supply pipe, and the cap and the recovery part are communicated with each other through an air discharge pipe so that an air pressure inside the supply part, an air pressure inside the cap, and an air pressure inside the recovery part having the vent port opened to atmosphere are synchronized.

8. An inkjet recording apparatus comprising:
the maintenance device according to claim 1; and
the inkjet head.
